(19) United States
(12) Patent Application Publication
(10) Pub. No.: US 2021/0206601 A1
(43) Pub. Date: Jul. 8, 2021

(54) ELEVATOR CABIN ASSEMBLY

(71) Applicant: FUNICULATOR AB, Stockholm (SE)

(72) Inventor: Fritz KING, Stockholm (SE)

(21) Appl. No.: 16/070,608

(22) PCT Filed: Dec. 22, 2016
(86) PCT No.: PCT/SE2016/051312

§ 371 Date: Jul. 17, 2018

(30) Foreign Application Priority Data
Jan. 18, 2016 (SE) 1650052-2

(51) Int. Cl. B66B 11/02; B29C 45/00

(52) U.S. Cl. CPC B66B 11/0226; B29C 45/0053; B66B 11/0206

(57) ABSTRACT

Cabin assembly (28) for an elevator system (15), the cabin assembly (28) comprising a cabin (10) and a chassis (12) configured to rotationally support the cabin (10), wherein the cabin (10) is injection moulded.

### TECHNICAL FIELD

The present disclosure generally relates to a cabin assembly for an elevator system. In particular, a cabin assembly for an elevator system, an elevator system comprising the cabin assembly and a method of producing the cabin assembly are provided.

### BACKGROUND

Various types of elevator systems for vertically transporting people and/or goods are known. The Articulated Funiculator (R) is a new concept of vertical transportation which is described in WO 2013159800 A1. With this concept, several trains of cabin assemblies (train cars) can traverse in loop configurations between stations separated by a large distance of, for example, 100 meters. Each cabin assembly may comprise a rotatably supported cabin such that the cabin can be maintained in a horizontal orientation as the cabin transitions between horizontal and vertical track portions of the loops.

U.S. Pat. No. 5,207,295 A discloses a prefabricated elevator cab comprising a plurality of injection moulded wall panels. The wall panels are connected by hinge seams such that the elevator cab can be elastically deformed to pass through a hoistway entrance and into a hoistway. U.S. Pat. No. 5,207,295 A aims to provide a lightweight, prefabricated elevator cab that reduces assembly time.

The concept of the Articulated Funiculator (R) opens up for the use of a wide range of track configurations. For example, practically endless combinations of straight, curved, inclined and helical track sections may be used. An elevator cab such as the one shown in U.S. Pat. No. 5,207,295 A is not suitable for these track configurations.

Moreover, although the elevator cab of U.S. Pat. No. 5,207,295 A is allegedly prefabricated, a substantial amount of installation work is required once the elevator cab has been moved into the hoistway. A simple installation procedure is valuable for the Articulated Funiculator (R) when a high number of cabin assemblies are used.

### SUMMARY

Accordingly, one object of the present disclosure is to provide a simple and cheap cabin assembly for an elevator system and an effective method of manufacturing the cabin assembly that enables a simple installation of the cabin assembly in the elevator system.

According to one aspect, a cabin assembly for an elevator system is provided, where the cabin assembly comprises a cabin and a chassis configured to rotationally support the cabin, wherein the cabin is injection moulded.

The injection moulding material may be any material suitable for a cabin according to the present disclosure such as a composite foam, a liquid or a semi-solid material. Examples of injection moulding materials include carbon fibers, metal fibers, glasses, elastomers, confections, thermoplastic polymers, thermosetting polymers, cementious plastics, resins and mixtures thereof. Injection moulding as referred to herein also includes pouring of moulding material into a cavity.

Throughout the present disclosure, the cabin may alternatively be referred to as a carriage, pod or car and the chassis may alternatively be referred to as a support structure or support member.

The cabin may be integrally injection moulded. With an integral injection moulding is meant a continuous (i.e. in one piece) and simultaneous injection moulding.

The cabin assembly may further comprise at least one thrust profile arranged on the cabin for being engaged to rotate the cabin. The rotation of the cabin may be used to maintain a cabin floor in a substantially horizontal orientation. However, the rotation may also be used to pitch the cabin in order to reduce horizontal forces on the passengers during horizontal accelerations and decelerations, i.e. to reduce the horizontal inertia forces on the passengers (or loads) during stops and starts.

The thrust profiles may be implemented as thrust discs. The cabin assembly may comprise one or several drive members configured to engage a respective thrust profile to rotate the cabin about the cabin axis. For rotation of the cabin, the at least one thrust profile may be directly or indirectly engaged. As one example of indirect engagement, a pair of drive member and thrust profile may be constituted by a drive member having a stator with coils for producing a magnetic field and a thrust profile having a rotor with magnets. Thus, the thrust profile may comprise or be constituted by the rotor of an electric motor.

The at least one thrust profile may be circular and arranged substantially concentric to a cabin axis extending through the cabin. For example, the cabin assembly may comprise two circular thrust profiles arranged substantially concentric to the cabin axis.

The cabin axis may or may not be constituted by a pitch axis, i.e. an axis perpendicular to a roll axis and a yaw axis when the cabin assembly is in an operational state on a track of an elevator system. That is, in case the chassis is also configured to rotationally support the cabin about a yaw axis, the cabin axis may not always constitute the pitch axis.

The cabin axis may extend substantially through a geometrical centre of the cabin. For example, in case the cabin has a substantially cylindrical appearance (e.g. barrel shape), the cabin axis may be constituted by the axis of the cylinder.

In case one or several thrust profiles are arranged on the cabin, the at least one thrust profile and the cabin may be integrally injection moulded. Alternatively, the thrust profiles may be attached to the cabin after injection moulding of the cabin.

Also the chassis of the cabin assembly may be injection moulded. The chassis may be injection moulded from the same or from a different material as the cabin. The chassis may be integrally injection moulded.

According to one variant, the cabin is injection moulded inside the chassis. Alternatively, the chassis may be injection moulded around the cabin. These options may be useful for some designs of the cabin assemblies when it is not possible to move the cabin into the chassis and/or when it is not possible to move the chassis to a position enclosing the cabin. Besides, these measures increase production efficiency and reduce the required production space.

The cabin assembly may further comprise a track coupling arrangement for movement along an elevator track. The track may include a single rail or several rails. One suitable track is constituted by a pair of rails. The track coupling arrangement may comprise at least one wheel assembly for engaging a rail portion of the track to move along the track.

The cabin assembly according to the present disclosure is not limited to any particular type of propulsion system. For example, all cabin assemblies in the elevator system may be driven with a cable or set of cables or each carriage may have an individual propulsion system. Two or more different types of propulsion systems may also be combined within the elevator system.

According to a further aspect, there is provided an elevator system comprising at least one cabin assembly according to the present disclosure. The elevator system may for example be used in a tall building or underground to access a deep underground subway station or a deep mine.

The elevator system may comprise a series of separated trains, each train having a plurality of cabin assemblies according to the present disclosure, tracks on which the trains are configured to ascend and descend, the tracks constituting at least one loop configuration and at least one up-bound station and at least one down-bound station vertically separated from the up-bound station, wherein the system is configured to stop trains at each up-bound and down-bound station simultaneously for unloading and loading passengers from the cabin assemblies. This type of elevator system, the Articulated Funiculator (R), is described in WO 2013159800 A1.

Alternatively, or in addition, the elevator system may comprise a transfer mechanism for transferring the cabin assembly to and/or from a position along an operational path of the elevator system. In other words, the transfer mechanism may be used to add and/or remove cabin assemblies to/from the operational path. The cabin assemblies may be completely assembled prior to being brought to the operational path of the elevator system. The transfer mechanism may be constituted by a robot, e.g. a six axis robot similar to, or identic to, an industrial robot.

According to a further aspect, there is provided a method of producing a cabin assembly for an elevator system, where the method comprises injection moulding a cabin, providing a chassis and rotationally coupling the cabin to the chassis. The step of injection moulding the cabin may further comprise the step of injection moulding a thrust profile integrally with the cabin for being engaged to rotate the cabin. The thrust profile according to this aspect may be constituted by any thrust profile according to the present disclosure.

The step of injection moulding the cabin may comprise the use of a core plate comprising a plurality of assembled sections where every other section has a wedge appearance pointing outwards from the cabin axis and every other section has a wedge appearance pointing inwards to the cabin axis.

### BRIEF DESCRIPTION OF THE DRAWINGS

Further details, advantages and aspects of the present disclosure will become apparent from the following embodiments taken in conjunction with the drawings, wherein:

FIG. 1a: schematically represents a perspective view of a cabin of a cabin assembly;

FIG. 1b: schematically represents a perspective view of a chassis of the cabin assembly;

FIG. 1c: schematically represents a side view of a cabin assembly comprising the cabin in FIG. 1a and the chassis in FIG. 1b;

FIG. 2a: schematically represents a perspective view of a cabin of a further cabin assembly;

FIG. 2b: schematically represents a side view of a cabin assembly comprising the cabin in FIG. 2a;

FIG. 3: schematically represents a side view of a further cabin assembly and a corresponding production method;

FIG. 4a: schematically represents a side view of a further cabin assembly; and

FIG. 4b: schematically represents a perspective view of the cabin assembly in FIG. 4a.

### DETAILED DESCRIPTION

In the following, a cabin assembly for an elevator system, an elevator system comprising the cabin assembly and a method of producing the cabin assembly will be described. The same reference numerals will be used to denote the same or similar structural features.

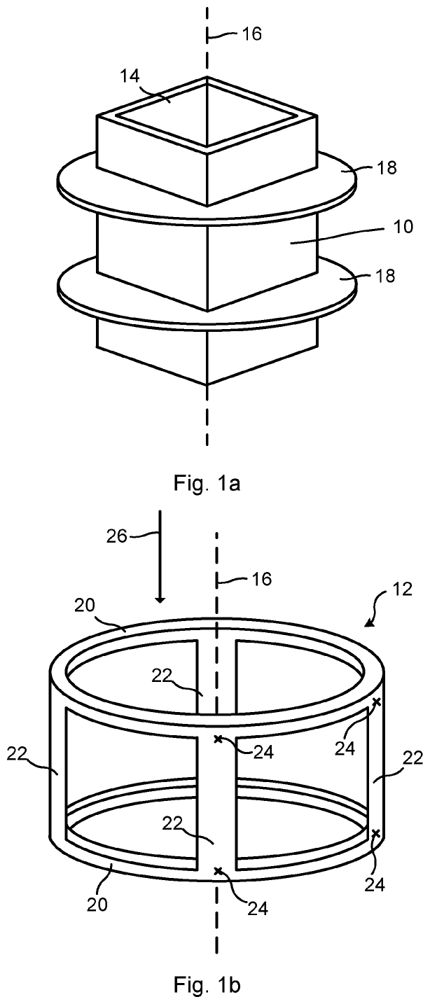

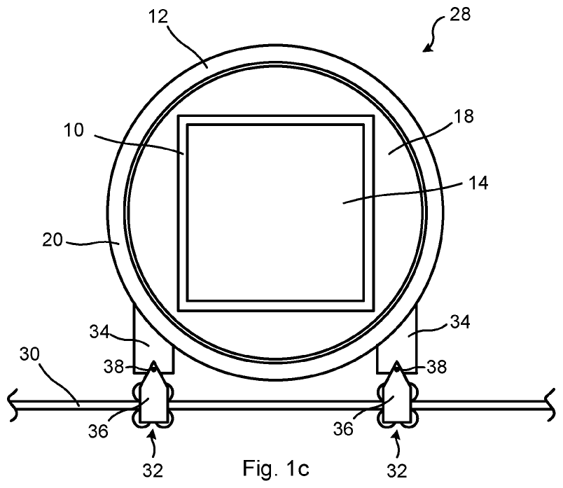

FIG. 1a schematically represents a perspective view of a cabin 10 of a cabin assembly and FIG. 1b schematically represents a perspective view of a chassis 12 of the cabin assembly. When the cabin assembly is assembled, the chassis 12 is configured to rotationally support the cabin 10.

The cabin 10 in FIG. 1a may be configured to carry one or several passengers and/or loads. The cabin 10 has a substantially cuboid appearance. The cabin 10 comprises five walls (one end side is opened). Alternative designs of the cabin 10, for example with a cylindrical appearance, are conceivable. In FIG. 1a, the cabin 10 is illustrated in a vertical orientation. For example, a door for entering the cabin 10 may be provided at an end side opening 14 of the cabin 10 facing upwards in FIG. 1a.

FIG. 1a further shows a cabin axis 16 about which the cabin 10 can be rotated. The cabin axis 16 is substantially coincident with the extension axis (longitudinal axis) of the cuboid shape of the cabin 10. The cabin axis 16 extends substantially through a geometrical centre of the cabin 10.

The cabin 10 comprises two circular thrust profiles 18. Each of the two thrust profiles 18 is arranged on the cabin 10 for being engaged to rotate the cabin 10. In FIG. 1a, the thrust profiles 18 are implemented as thrust discs having a flat circular appearance. The cabin assembly may comprise one or several drive members configured to engage a respective thrust profile 18 to rotate the cabin 10 about the cabin axis 16. The two thrust profiles 18 are arranged substantially concentric to the cabin axis 16.

Although two circular thrust profiles 18 are illustrated in FIG. 1a, the cabin 10 may comprise only one thrust profile 18 or more than two thrust profiles 18. In case only one thrust profile 18 is provided, the thrust profile 18 may be positioned anywhere along the cabin axis 16, for example substantially flush with an end face of the cabin 10 or substantially at a centre position along the longitudinal axis. In case two or more thrust profiles 18 are provided, these may be substantially evenly distributed along the longitudinal axis of the cabin 10. In this variant, an opening member (e.g. one or two doors) may be provided at one or both end faces of the cabin 10.

In FIG. 1a, the cabin 10 and the thrust profiles 18 are integrally injection moulded. As mentioned in the previous section, a wide range of injection moulding materials may be used for the moulding. The cabin 10 is hollow and the lower end side (not shown), opposite to the upper end side opening 14, is closed.

In order to mould the cabin 10 and the thrust profiles 18, an outer mould and an inner mould may be used. The cabin 10 and the thrust profiles 18 may thus be injection moulded in a vertical orientation (i.e. where the cabin axis 16 extends substantially in a vertical direction). In other words, the outer and inner moulds may stand during the moulding procedure. The outer and inner moulds may each have a cylindrical appearance although alternative designs are conceivable.

Each of the inner mould and the outer mould may be constituted by several separable sections oriented substantially parallel with the cabin axis 16. In their mounted states, the outer mould and the inner mould may be said to constitute a cavity plate and a core plate, respectively. Thus, a cavity having the shape of the cabin 10 and the two thrust profiles 18 is formed when the moulds are assembled and brought together. This integral moulding procedure is a one piece fabrication generating exact measurements.

The core plate or inner mould comprises a plurality of sections where every other section has a wedge appearance pointing outwards from the cabin axis 16 and every other section has a wedge appearance pointing inwards to the cabin axis 16. The inner mould may for example comprise sixteen wedged sections (eight pointing outwards and eight pointing inwards). In the assembled state, the plurality of sections of the inner mould form an outer profile corresponding to the interior profile of the cabin 10 (i.e. cuboid in this case).

The outer mould may for example comprise four sections. The outer and inner moulds composed of several separable sections may be said to comprise “break points”.

When the moulding is completed and the moulding material has set, the inner cylindrical mould may thus be disassembled or “collapsed” by first removing (moving inwardly) the sections having wedge appearance pointing outwards to the cabin axis 16 and then removing (moving inwardly) the sections having a wedge appearance pointing inwards to the cabin axis 16. The outer cylindrical mould may be disassembled by moving each of its sections outwardly.

Upon completion of the moulding, the cabin 10 may be subjected to some final machining, e.g. to cut out window openings. However, all window openings may also be provided by the moulding. Any further installation work, such as electric installations and installation of doors, may be carried out at this stage, or after the cabin 10 is installed to the chassis 12, as described below.

Each thrust profile 18 may comprise or may constitute a rotor provided with magnets. By activating a stator provided with coils to produce a magnetic field, the thrust profile 18, and consequently also the cabin 10, can be driven to rotate about the cabin axis 16. The stator therefore constitutes one example of a drive member. The cabin assembly may be configured such that the cabin 10 can rotate 360° about the cabin axis 16.

The drive member may however be configured to engage the thrust profile 18 in alternative ways. For example, both the thrust profile 18 and the drive member may comprise, or may be constituted by, meshing bevel gears. In this case, the bevel gear on the thrust profile 18 may have an outer diameter substantially conforming to, or being slightly smaller than, the diameter of the thrust profile 18.

The chassis 12 in FIG. 1b is constituted by a frame with a substantially cylindrical appearance. The cylindrical frame is constituted by two parallel rings 20 and four interconnecting struts 22. The struts 22 are substantially evenly distributed around the cabin axis 16.

More or less than four struts 22 may be used to interconnect the rings 20. The two rings 20 and the struts 22 interconnecting the two rings 20 may be integrally injection moulded. That is, the rings 20 and the struts 22 may be moulded in a continuous cavity. The moulding procedure for the chassis 12 may be the same as for the cabin 10 in that an inner mould and an outer mould, each composed by a plurality of sections, may be used.

Upon completion of the injection moulding of the chassis 12, one or several drive members (not shown) are provided on the chassis 12. Each drive member is configured to engage a respective thrust profile 18 to rotate the cabin 10 about the cabin axis 16. As mentioned above, one example of a drive member is a stator with coils. In FIG. 1b, four wheel assembly attachment points 24 are also shown on the chassis 12.

The cabin 10 may then be vertically lowered into the chassis 12, as indicated by arrow 26. However, the chassis 12 may be oriented differently, e.g. the chassis 12 may stand up and the cabin 10 can be inserted horizontally into the chassis 12.

The spacing between the two thrust profiles 18 along the cabin axis 16 corresponds to the spacing between the two rings 20. Bearings (not shown) may be provided between the respective thrust profiles 18 and rings 20 to allow a relative rotation of the cabin 10 and the chassis 12 about the cabin axis 16. Examples of bearings include roller bearings and frictional bearings (i.e. by the provision of low friction materials on the contacting surfaces).

FIG. 1c schematically represents a side view of a cabin assembly 28 comprising the cabin 10 in FIG. 1a and the chassis 12 in FIG. 1b. In FIG. 1c, the cabin assembly 28 is in an operational state on a track 30 of an elevator system. This type of cabin assembly 28 comprising a cabin 10 with a cuboid appearance rotationally supported to (e.g. inside) a chassis 12 with a cylindrical appearance may be referred to as a circular pod. With the cabin assembly 28 of FIG. 1c, the cabin axis 16 coincides with the pitch axis.

The cabin assembly 28 further comprises four wheel assemblies 32 (only two shown in FIG. 1c). Each wheel assembly 32 comprises a leg or attachment assembly 34 fixedly attached to the chassis 12 and a wheel support 36 holding a plurality of wheels (e.g. six) for engaging rails of the track 30. The legs 34 are attached to the respective wheel assembly attachment points 24 shown in FIG. 1b. However, the legs 34 may alternatively be integrally injection moulded with the chassis 12. Each wheel support 36 is pivotally connected to a leg 34 for rotation about a pivot axis 38 substantially parallel with the cabin axis 16.

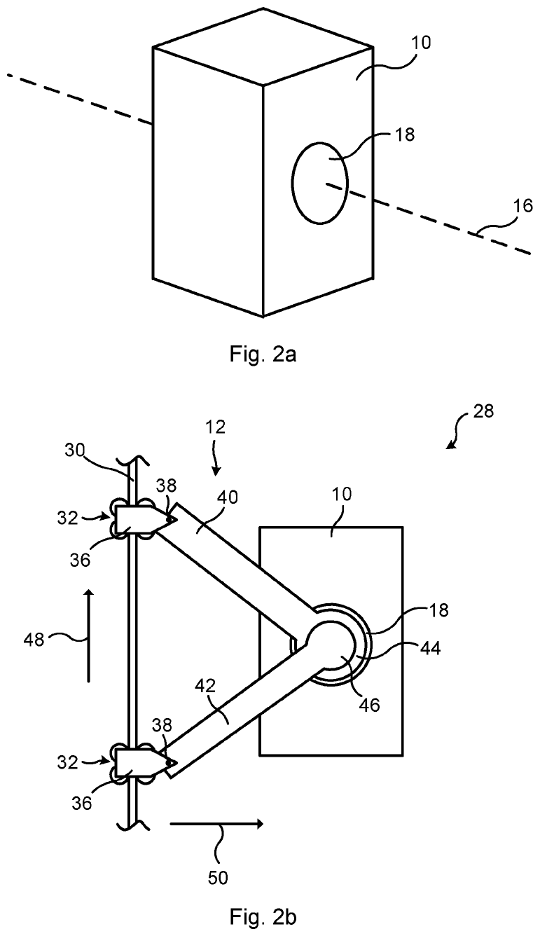

FIG. 2a schematically represents a perspective view of a further cabin 10 and FIG. 2b schematically represents a side view of a cabin assembly 28 comprising the cabin 10 in FIG. 2a.

As can be seen in FIG. 2a, the cabin 10 has a vertically elongated cuboid appearance. The cabin 10 comprises a circular thrust profile 18 provided at one of its vertical sides. The thrust profile 18 is configured to be engaged to rotate the cabin 10 about the cabin axis 16. Although various different types of thrust profiles 18 are conceivable, the thrust profile 18 in FIG. 2a is a rotor with magnets. The rotor body is integrally injection moulded with the cabin 10 in a moulding process as described above and the magnets have subsequently been attached to the rotor body. An opening member (e.g. one or two doors) may be provided at an opening of the cuboid cabin 10 at a side opposite to the side of the thrust profile 18.

As shown in FIG. 2b, the cabin 10 is rotationally supported by a chassis 12 connected at one of the sides of the cabin 10, e.g. by a swivel mount. The cabin 10 can rotate relative to the chassis 12 about the cabin axis 16. This type of cabin assembly 28 may be referred to as a box pod.

The chassis 12 in FIG. 2b is composed of two interconnecting support members in the form of linkages 40, 42. The upper linkage 40 comprises a support member 44 in the form of a plate rotatably coupled to the swivel mount of the cabin 10 for rotation about the cabin axis 16. The lower linkage 42 comprises a support member 46 in the form of a plate rotatably coupled to the swivel mount of the cabin 10 (or to the support member 44) for rotation about the cabin axis 16.

Each linkage 40, 42 is further rotationally coupled to a wheel assembly 32 for rotation about a respective pivot axis 38. The linkages 40, 42 are injection moulded.

The chassis 12 can thereby move between an expanded state and a collapsed state. In the expanded state, the wheel assemblies 32 are brought closer to each other along the track 30 in the travel direction 48. The cabin 10 is thereby moved away from the track 30 in a direction 50 perpendicular to the travel direction 48 and is free to rotate about the cabin axis 16 without interfering with the track 30.

In the collapsed state, the wheel assemblies 32 are distanced from each other along the track 30 in the travel direction 48 such that the cabin 10 can be brought close to the track 30 (e.g. with one of the longitudinal sides of the cabin 10) to adopt a compact configuration requiring reduced elevator shaft areas. The cabin 10 can be brought to a state, for example, between the wheel assemblies 32, as seen in the travel direction 48.

A drive member in the form of a stator with coils (not shown) is provided on the support member 44. The coils of the stator produce a magnetic field to engage the rotor on the thrust profile 18 to rotate the cabin 10 about the cabin axis 16. With the cabin assembly 28 of FIG. 2b, the cabin axis 16 coincides with the pitch axis.

Although a chassis 12 comprising two linkages 40, 42 is shown, the chassis 12 may alternatively be constituted by a single rigid support member. This support member may be integrally injection moulded.

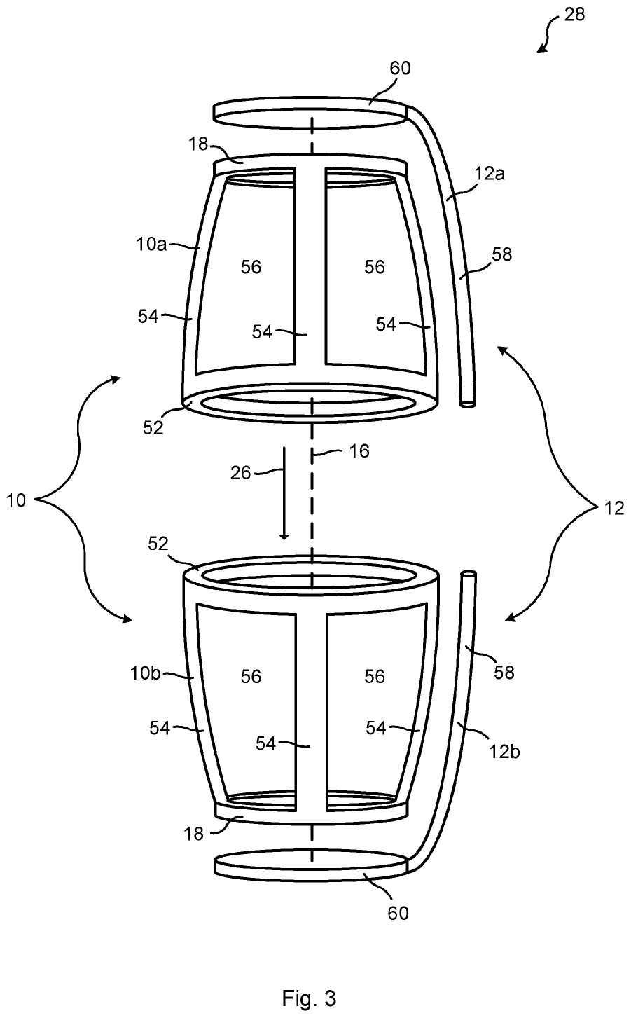

FIG. 3 schematically represents a side view of a further cabin assembly 28 and a corresponding production method. The cabin assembly 28 comprises a cabin 10 composed of two cabin halves 10a, 10b jointly forming a barrel shape. Each cabin half 10a, 10b comprises a thrust profile 18, a ring 52 and four struts 54 (only three are visible in FIG. 3) interconnecting the thrust profile 18 and the ring 52. Moreover, each cabin half 10a, 10b is provided with four apertures 56 for subsequent installation of windows.

Since the cabin 10 has a barrel shaped appearance, this cabin assembly 28 may therefore be referred to as a barrel pod. The cabin 10 has an outer profile that is substantially rotation symmetric with respect to the cabin axis 16.

The chassis 12 is composed of two chassis sections 12a, 12b, each associated with, and configured to rotationally support, a cabin half 10a, 10b. A circular thrust profile 18 is fixedly attached to each end of the cabin halves 10a, 10b. Each chassis section 12a, 12b comprises an arm 58 and a support member 60.

The cabin 10 and chassis 12 of the cabin assembly 28 may be injection moulded by first simultaneously injection moulding one cabin half 10a and a corresponding chassis section 12a and then simultaneously injection moulding the other cabin half 10b and the corresponding chassis section 12b by using the same mould. Thus, each of the cabin half 10a, cabin half 10b, chassis section 12a and chassis section 12b is integrally injection moulded.

One cabin half 10a and one chassis section 12a may then be lowered along the cabin axis 16, as illustrated by the arrow 26, to mate with and be attached to the other cabin half 10b and chassis section 12b, respectively. The arms 58 may be connected to each other and can be rotationally supported by a further support member (not shown) for rotation about a yaw axis (not shown). The yaw axis is substantially perpendicular to the cabin axis 16 and to the track 30. With the cabin assembly 28 of FIG. 3, the cabin 10 may be allowed to rotate about the yaw axis and about the cabin axis 16 which is perpendicular to the yaw axis (the cabin axis 16 may not always constitute the pitch axis).

Rotational supports, e.g. swivel mounts, may be provided at the support members 60 of the respective cabin halves 10a, 10b to rotationally support the cabin 10 for rotation about the cabin axis 16. Drive members may also be provided at corresponding positions on the chassis 12 (i.e. at both support members 60) to engage the thrust profiles 18 on the respective cabin half 10a, 10b to rotate the cabin 10 about the cabin axis 16.

Although the cabin 10 in FIG. 3 has been described as formed from two integrally moulded cabin halves 10a, 10b, the entire cabin 10 of a barrel shape may be integrally injection moulded. Similarly, the entire chassis 12 may be integrally injection moulded.

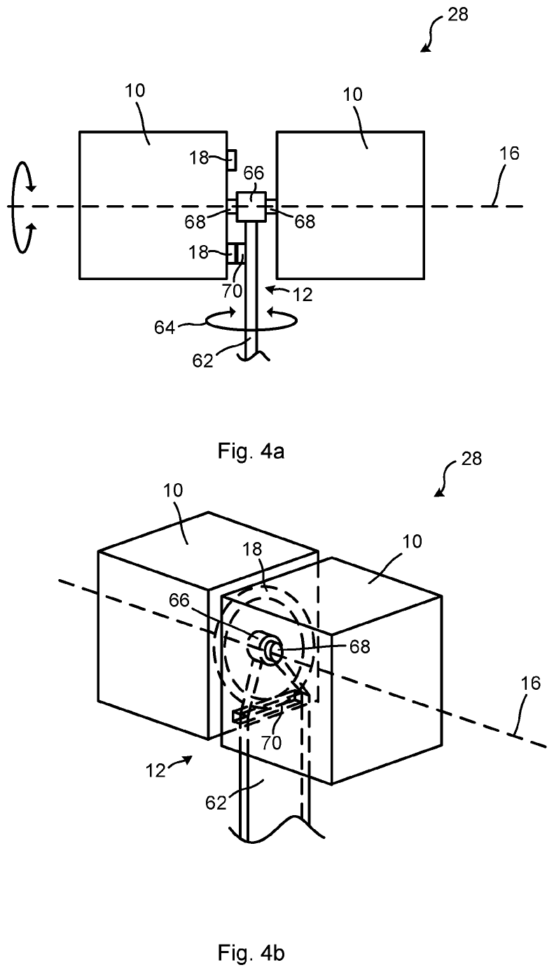

FIG. 4a schematically represents a side view of a further cabin assembly 28 and FIG. 4b schematically represents a perspective view of the cabin assembly 28 in FIG. 4a. This cabin assembly 28, which may be referred to as a split cabin, comprises two cabins 10 and a chassis 12 connected to the cabins 10 between the cabins 10.

Each cabin 10 has a substantially cuboid appearance. However, each or one of the cabins 10 may alternatively be, for example, circular or barrel shaped. The chassis 12 comprises an arm 62 arranged to rotate about a yaw axis, as illustrated by arrow 64. The rotation about the yaw axis may however be omitted. The chassis 12 further comprises a support member 66 constituting a hub. A rod member 68, interconnecting the two cabins 10, is rotationally held by the support member 66 to allow the cabins 10 to jointly rotate about the cabin axis 16. The chassis 12 is thereby configured to rotationally support the cabin 10 for rotation about the cabin axis 16.

As shown in FIG. 4a, only one of the cabins 10 is provided with a thrust profile 18. The thrust profile 18 comprises a rotor for being engaged by a stator 70 (driving member) on the chassis 12. FIG. 4b shows that the thrust profile 18 on one of the cabins 10 has a continuous circular shape while the stator 70 has a compact appearance that does not encircle the cabin axis 16. Although the thrust profile 18 has a continuous circular shape in FIGS. 4a and 4b, it may alternatively be discontinuous, for example in the shape of a partial circle.

Each cabin 10 in FIGS. 4a and 4b is integrally injection moulded. Additionally, also the arm 62 of the chassis 12 is integrally injection moulded.

While the present disclosure has been described with reference to exemplary embodiments, it will be appreciated that the present invention is not limited to what has been described above. For example, it will be appreciated that the dimensions of the parts may be varied as needed. Accordingly, it is intended that the present invention may be limited only by the scope of the claims appended hereto.

1. A cabin assembly for an elevator system, the cabin assembly comprising:
a cabin, and
a chassis configured to rotationally support the cabin, wherein the cabin is integrally injection moulded, or wherein the cabin comprises two cabin halves and each cabin half is integrally injection moulded.

2. The cabin assembly according to claim 1, further comprising at least one thrust profile arranged on the cabin for being engaged to rotate the cabin.

3. The cabin assembly according to claim 2, wherein the at least one thrust profile is circular and arranged substantially concentric to a cabin axis extending through the cabin.

4. The cabin assembly according to claim 3, wherein the cabin axis extends substantially through a geometrical centre of the cabin.

5. The cabin assembly according to claim 2, wherein the at least one circular thrust profile and the cabin are integrally injection moulded.

6. The cabin assembly according to claim 1, wherein the chassis is injection moulded.

7. The cabin assembly according to claim 6, wherein the chassis is integrally injection moulded.

8. An elevator system comprising at least one cabin assembly according to claim 1.

9. A method of producing a cabin assembly for an elevator system, the method comprising:
integrally injection moulding a cabin, or integrally injection moulding two cabin halves and attaching the cabin halves to provide a cabin,
providing a chassis, and
rotationally coupling the cabin to the chassis.

10. The method according to claim 9, wherein the method comprising integrally injection moulding the cabin inside the chassis.

11. The method according to claim 9, wherein the method comprising integrally injection moulding the chassis around the cabin.

12. The method according to claim 9, wherein the injection moulding of the cabin comprises injection moulding at least one thrust profile integrally with the cabin for being engaged to rotate the cabin.

13. The method according to claim 9, wherein the step of integrally injection moulding the cabin comprises the use of a core plate comprising a plurality of assembled sections where every other section has a wedge appearance pointing outwards from a cabin axis and every other section has a wedge appearance pointing inwards to the cabin axis.

14. The method according to claim 9, wherein the injection moulding of the cabin is carried out in a vertical orientation such that a cabin axis extends substantially in a vertical direction.
